(19) United States
(12) Patent Application Publication
(10) Pub. No.: US 2010/0005485 A1
(43) Pub. Date: Jan. 7, 2010

(54) ANNOTATION OF VIDEO FOOTAGE AND PERSONALISED VIDEO GENERATION

(75) Inventors: Qi Tian, Singapore (SG); Lingyu Duan, Singapore (SG); Changsheng Xu, Singapore (SG); Kongwah Wan, Singapore (SG); Joo Hwee Lim, Singapore (SG); Xin Guo Yu, Singapore (SG)

Correspondence Address: VOLPE AND KOENIG, P.C., UNITED PLAZA, SUITE 1600, 30 SOUTH 17TH STREET, PHILADELPHIA, PA, 19103, US

(73) Assignee: AGENCY FOR SCIENCE, TECHNOLOGY AND RESEARCH, (SG)

(21) Appl. No.: 12/158,012

(22) PCT Filed: Dec. 19, 2005
(86) PCT No.: PCT/SG05/00425

§ 371 Date: Mar. 20, 2009

(51) Int. Cl. H04N 7/10; G06F 17/27; G06N 5/02

(52) U.S. Cl. 725/32; 704/9; 706/54

(57) ABSTRACT

A method of annotating footage that includes a structured text broadcast stream, a video stream and an audio stream, the method includes the steps of: extracting directly or indirectly one or more keywords and/or features from at least said structured text broadcast streams, temporally annotating said footage with said keywords and/or features analysing temporally adjacent annotated keywords and/or features to determine information about one or more events within said footage. Also provided are: a data store for storing video footage, a method of generation of a personalised video summary, a system for annotating footage and a system for generation of a personalised video summary.

### FIELD OF INVENTION

The invention relates to a method of annotating video footage, a data store for storing annotated video footage, a method of generation of a personalised video summary, and a system for annotating video footage and a system for generation of a personalised video summary.

### BACKGROUND

Video footage, particularly sports footage, often includes periods of relative inactivity followed by more interesting or high activity periods. Live broadcasts of such video footage often include commentary and/or replays of the later as these are of more interest to the watcher. It is also common for later broadcasts of the footage to provide a video summary of the footage, which will often be a combination of the most interesting replays. Typically a human production director manually chooses which portions of footage to use for replays and which replays to use in a video summary.

It is known in the art to automatically analyse video footage to attempt to replicate the decision process of the human production director. Generally prior art methods attempt to identify “events” within the footage, such as a goal in football, and determine the “boundaries” of the event that will form the replay. An index of the footage may be formed that identifies the time of each event and boundaries for the replay. In live broadcasts the index may be used for automatically inserting a replay into the broadcast or in later broadcasts the index may be used to generate a video summary. Generation of the video summary is therefore a summary of the events within the footage.

For example in a paper by Ekin and A. M. Tekalp, entitled “Automatic Soccer Video Analysis and Summarization”, published in Symp. Electronic Imaging: Science and Technology: Storage and Retrieval for Image and Video Databases IV, IS&T/SPI03, January 2003, CA, a soccer video analysis and summarization framework is disclosed using cinematic and object-based features, such as dominant colour region detection, robust shot detection, shot view classification, and some higher level detection such as goals, referee, and penalty-box, and replay detection. However this does not allow identification of goals by a specific player of a team.

N. Babaguchi, Y. Kawai and T. Kitahashi, in a paper entitled “Event Based Indexing of Broadcasted Sports Video by Inter-modal Collaboration,” published in IEEE Trans. Multimedia, vol. 4, no. 1, pp. 68-75, March 2002 disclose a semantic analysis method for broadcasting sports video based on video/audio and closed caption (CC) text. The closed captioned text is created by the manual transcription of commentator's speech for the sports game. The video, audio and CC are processed to detect highlights, segment the story, and extract play and player.

The CC from commentators' speech is not structured, and on average, for one minute long video there are as many as 10 sentences, or about 100 words. Also due to the nature of commentator language it is difficult to parse these sentences and extract information. In fact a special technique known as Natural Language Parsing (NLP), is required to extract information from the text. Techniques to parse unstructured text are highly computationally intensive and provided only limited accuracy and effectiveness. Additionally, speech transcription of CC text results in the delay of reporting live sports events.

In a further example in a paper by DongQing Zhang, and Shih-Fu Chang, entitled “Event Detection in Baseball Video Using Superimposed Caption Recognition”, published in ACM Multimedia 2002, Juan Les Pins, France, Dec. 1-6, 2002. (ACM MM 2002) a system for baseball video event detection and summarization using superimposed caption text detection and recognition, called video OCR is disclosed. The system detects different types of events in baseball video including scoring and last pitch of each batter. The method is good for detecting game structure and certain events. However, because of the difficulties in achieving high accuracy in video OCR, its use for semantic analysis of sports video has been limited.

Correctly identifying who or which sportsperson is involved in an event has proven a particularly difficult problem to solve. Other useful information about each event includes when it occurred, what type of event and where did the event occur. Prior art methods of indexing and classification have failed to comprehensively characterise each event in the footage.

U.S. Pat. No. 6,751,776 discloses an automatic video content summarization system that is able to create personalized multimedia summary based on the user-specified theme. Natural language processing (NLP) and video analysis techniques to extract important keywords from the closed caption (CC) text as well as prominent visual features from the video footage. A Bayesian statistical framework is used, which naturally integrates the user theme, the heuristics and the theme-relevant video characteristics within a unified platform. However the use of NPL may be highly computationally intensive and may only provide limited accuracy and effectiveness because of the limitations of NPL technologies.

A need therefore exists to address at least one of the above problems.

### SUMMARY

In accordance with a first aspect of the invention there is provided a method of annotating footage that includes a structured text broadcast stream, a video stream and an audio stream, comprising the steps of:

extracting directly or indirectly one or more keywords and/or features from at least said structured text broadcast streams,

temporally annotating said footage with said keywords and/or features

analysing temporally adjacent annotated keywords and/or features to determine information about one or more events within said footage.

Said step of analysing temporally adjacent annotated features and/or temporal information may comprise:

detecting one or more events in said video footage according to where at least one of said keywords and/or features meets one or more predetermined criterion, and

determining information about each detected event from annotated keywords and/or features temporally adjacent to each detected event.

Said step of detecting one or more events may comprise the step of comparing at least one keyword and/or feature extracted from the structured text broadcast stream to one or more predetermined criterion.

Said step of determining information may comprise the step of indexing each of said events using a play keyword extracted from said structured text broadcast stream.

Said step of indexing may further comprise the step of indexing each of said events using a time stamp extracted from said structured text broadcast stream.

Said step of indexing may further comprise the step of refining the indexing of each of said events using a video keyword extracted from said video stream.

Said step of indexing may further comprise the step of refining the indexing of each of said events using an audio keyword extracted from said audio stream.

Said video footage may relate to at least one sportsperson playing a sport, and said step of extracting may further comprise the step of extracting which sportsperson features in each event from the structured text broadcast stream, and said step of annotating may comprise annotating said footage with said sportsperson.

Said step of extracting may further comprise the step of extracting when each event occurred, what happened in each event and where each event happened from at least one of said streams, and wherein said step of annotating may further comprise annotating said footage according to when each event occurred, what happened in each event and where each event happened.

Said structured text broadcast may be sports webcasting text (SWT).

Said keywords and/or features may comprises one or more keyword(s), and wherein each keyword may be determined from one or more low level features, and wherein each low level feature may be extracted from said footage.

Said one or more keyword(s) may comprise a play keyword extracted from said structured text broadcast stream, a video keyword extracted from said video stream and an audio keyword extracted from said audio stream.

Said event may comprises a state of increased action within the footage chosen from one or more of the following list: goal, free-kick, corner kick, red-card, yellow-card, where the action is football footage.

Said one or more predetermined criterion may comprise said play keyword matching one of said states of increased action.

In accordance with a second aspect of the invention there is provided a data store for storing video footage, characterised in that in use said video footage is annotated according to the method in any of the preceding claims.

In accordance with a third aspect of the invention there is provided a method of generation of a personalised video summary comprising the steps of:

storing video footage including one or more events, wherein each of said events is classified according to the method of annotating footage above;

receiving preferences for said personalised video summary;

selecting events to include from said stored video footage where the classification of a given event satisfies said preferences; and

generating said personalised video summary from said selected events.

In accordance with a forth aspect of the invention there is provided a A system for annotating footage comprising a data store storing said footage and a computer program;

a processor configured to execute said computer program to carry out the steps of the method of annotating footage above.

In accordance with a fifth aspect of the invention there is provided a system for generation of a personalised video summary comprising

a data store storing said footage and a computer program;

a processor configured to execute said computer program to carry out the steps of the method of generation of a personalised video summary above.

### BRIEF DESCRIPTION OF THE DRAWINGS

Example embodiments of the invention will now be described with reference to the drawings, in which:

FIG. 1 is a flow diagram of a method for video indexing.

FIG. 2 is a flow diagram of a method for personalised video generation.

FIG. 3 is a schematic diagram of a system for indexing video and generating personalised video.

FIG. 4 is a schematic diagram of the indexing and classification process.

FIG. 5 is a flow diagram of PKW extraction from SWT.

FIG. 6 is a flow diagram of PKW extraction from ADT.

FIG. 7 is a table of an example of SWT.

FIG. 8 is a table including a sample of SWT for a goal event.

FIG. 9 is a flow diagram of parsing input video stream into play, replay and break video segments, and commercials.

FIG. 10 is a flow diagram of VKW extraction from the play/replay/break video segments.

FIG. 11 is a flow diagram of AKW extraction.

FIG. 12 is a flow diagram of a method for automatic video summary creation from user preferences.

FIG. 13 is a flow diagram of a method for automatic video summary creation from a text summary.

FIG. 14 is a flow diagram of replay video segment detection, parsing and classification.

FIG. 15 is a flow diagram of a method of learning weighting for different types of replays from human production directors.

FIG. 16 is a flow diagram of an algorithm for the soccer or football ball detection.

FIG. 17 is a flow diagram of an algorithm of the real time detection of the goalmouth.

FIG. 18 is a diagram of the three streams of footage annotated with semantic content.

FIG. 19 is a diagram of the three streams of footage annotated with semantic content to create a personalized video summary

### DETAILED DESCRIPTION

Video footage processing, particularly automatic video processing, requires some knowledge of the content of the footage. For example, in order to generate a video summary of events within the footage, the original footage needs some form of annotation of the footage. In this way a personalised video summary may be generated that only includes events that meet one or more criterion.

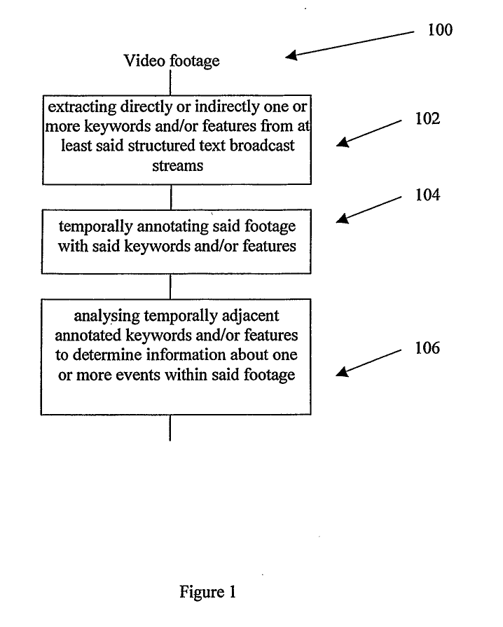

FIG. 1 exemplifies an example embodiment of a method for classifying events within video footage. Video footage 100 may be stored or received live including three different streams: structured text broadcast (STB), video and audio. In step 102, one or more features and/or temporal information are extracted from at least said structured text broadcast stream. In step 104, the footage is temporally annotated with the features and/or temporal information. In step 106 temporally adjacent annotated features and/or temporal information are analysed to determine information about one or more events within said footage.

An example application is annotating sports video. In sports video typical annotations may include the time of an event, the player or team involved in the event and the nature or type of event. The venue of the event may also be used as an annotation. For the following embodiments football or soccer or football will be used as one example, although it will be appreciated that other embodiments are not so restricted and may cover annotated video generally.

A user of sports video will typically have a preference for given players or teams and/or a particular nature or type of event. Accordingly once annotated, events that meet the preferences may be easily selected from the annotated footage to generate a personalised video summary. The summary may include video, audio and/or STB streams.

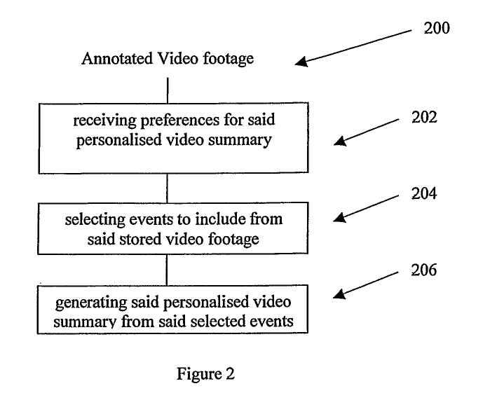

FIG. 2 shows an example embodiment of a method for personalised video generation from stored video footage, where the footage has been annotated. In step 202, the preferences are set for which events to include. In step 204, events that have annotations that satisfy the set preferences are selected from the stored video footage. In step 206, the summary is generated from the selected events.

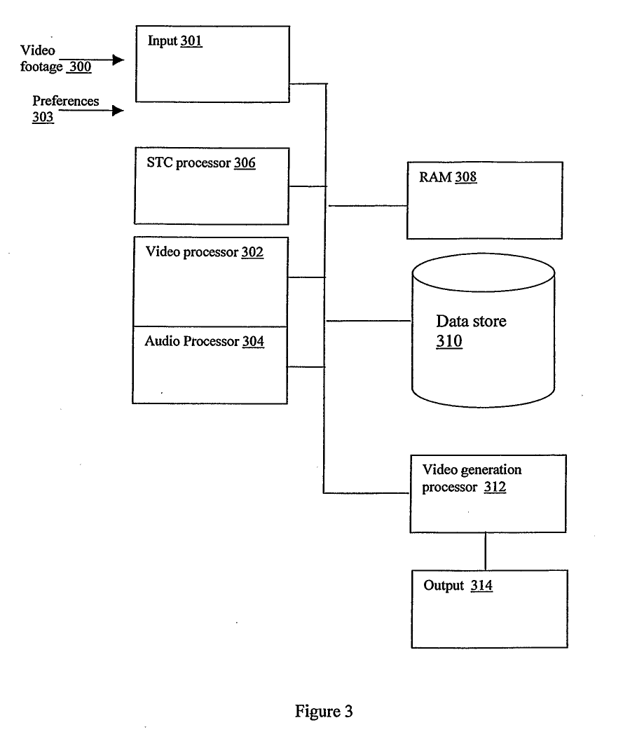

The methods shown in FIGS. 1 and 2 may be employed independently or in combination. Typically they may be combined and employed in a system as shown in FIG. 3.

FIG. 3 shows an example embodiment of a system for indexing video and generating personalised video. Video footage 300 is received at the input 301. The content data may be stored or processed immediately. Each stream of the video footage is separated and provided correspondingly to a video processor 302, an audio processor 304 and an STB processor 306, to annotate the video footage. Each processor may interface with temporary data storage 308 (for example, Random Access Memory (RAM)) and permanent data store 310 (for example, a hard disk), which includes algorithms and/or further data to assist the classification of each event. The annotated footage is then stored in a database in the permanent data store 310.

User preferences 303 are also received at the input 301. Video generation processor 312 receives the preferences and scans the database for events with annotations that satisfy the preferences. The summary video is provided at the output 314, or may be stored in the permanent data store 310 for later retrieval.

Each processor may take the form of a separate programmed digital signal processor (DSP) or may be combined into a single processor or computer.

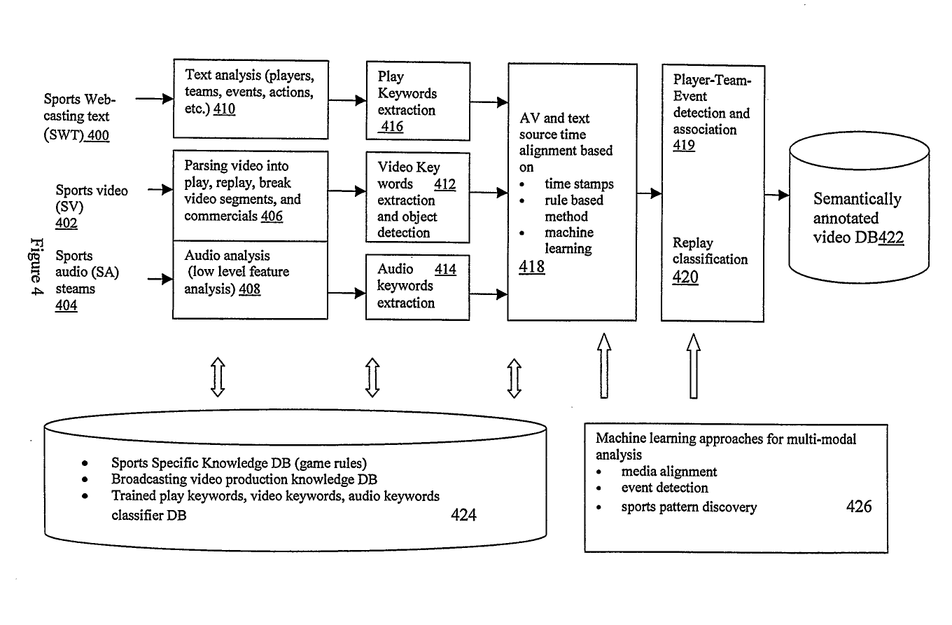

In an example embodiment the content data is received (step 100 in FIG. 1) as shown in FIG. 4, as an STB stream 400, a video stream 402 and an audio stream 404. The data may be received and processed in real time or may be stored for offline analysis. The STB stream may be created separately from the video/audio streams or from a different source, but may easily be integrated with the video and audio streams for processing.

In order to facilitate annotation, a framework is necessary. In an example embodiment each of the streams of the footage is analysed and “keywords” are extracted (step 102 in FIG. 1) based on both spatial and temporal features in each of the streams. These features are mainly low-level features of the three media contents. For the video stream, the features may include colour and intensities, histograms, motion parameters of key frames and video shots. For the audio stream, the features may include Mel frequency Cepstral Coefficients (MFCC), Zero Crossing Rate (ZCR), linear prediction coefficient (LPC), short time energy (ST), spectral power (SP). For the STB steam, the features may include extracted terms and their distributions.

The video features, for example, have two axes: temporal and spatial, the former refers to its variations along time, the lafter refers to its variations along spatial dimension, like horizontal and vertical positions.

For example the STB stream 400 is subjected to STB analysis 410 including parsing the text to extract key event information such as who, what where and when. Then one or more “play keywords” 416 (PKW) are extracted from the STB stream. The keywords are defined depending on the type of footage and the requirements of annotation.

The video stream 402 is subjected to video analysis 406 including video structural parsing into play, replay and commercial video segments. Then one or more “video keywords” 412 (VKW) are extracted from the video stream and/or object detection is carried out.

The audio stream 404 is subjected to audio analysis 408 includes audio low-level analysis. Then one or more “audio keywords” 414 (AKW) are extracted from the audio stream.

Once the keywords are extracted the keywords may be aligned in time for each stream 418. Player, Team and Event detection and association 419 takes place using the keywords. Here events refer to actions that are taking place during sports games. For instance, events for soccer game include goal, free kick, corner kick, red-card, yellow-card, etc.; events for tennis game include serve, deuce, etc. Each replay may then be classified 420, for example by identifying who features in each event, when each event occurred, what happened and where each event occurred. The semantically annotated video footage may then be stored in a database 422.

### STB Analysis

STB allows easier parsing of information that is less computationally intensive and more effective compared to parsing transcriptions of commentary. Normal commentary may have long sentences, may be unstructured and may involve opinions and/or informal language. All of this combines to make it very difficult to reliably extract meaningful information about events from the commentary. Prior art Natural Language Parsing (NLP) techniques have been used to parse such transcribed commentary, but this has proven highly computationally intensive and only provides limited accuracy and effectiveness.

An example of an STB stream is Sports Web casting Text (SWT). Sports game annotators manually create SWT in real-time, and the SWT stream is broadcast on the Internet. SWT is structured text that describes all the actions of sports game with relatively low delay. This allows extraction of information such as the time of an event, the player or team involved in the event and the nature or type of event. Typically SWT provides information on action and associated players/teams approximately every minute during a live game.

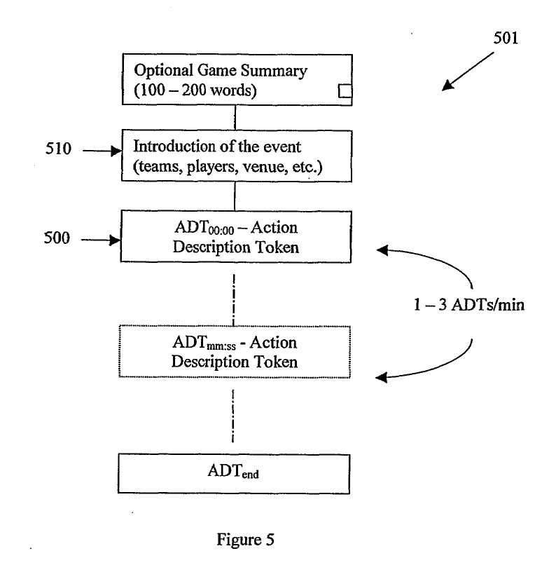

SWT follows an established structure with regular time stamps. FIG. 5 shows the structure of an example SWT stream 501. Each sentence is typically short and the language simple, typically relating to action taking place in the footage. This allows the information to be parsed more easily and more reliably than in the prior art. The SWT stream consists of a sequence of action description tokens (ADT) 500. Current commercially available SWT typically delivers 1 to 3 ADT(s) per minute depending on the activity levels each minute.

The PKW extracted from the SWT may be used to identify events and may be used to classify each event.

In order to analyse the SWT and generate the PKW over the whole footage (416 in FIG. 4), the game introduction 510 is first parsed to obtain general information and then each of the ADTs 500 are parsed to get temporal information relating to events within the footage. Examples of parsing include processing of stop words, stems and synonyms on the SWT stream.

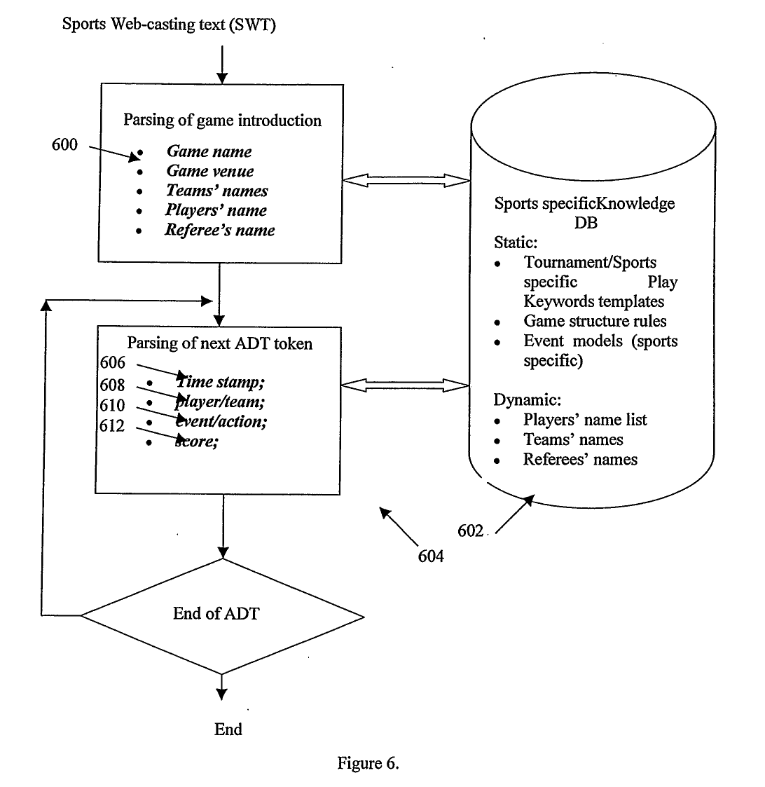

The PKW may consist of a static and dynamic component. In FIG. 6, the static part 600 is extracted and stored in the Sport Keywords Database (SKDB) 602; including a set of sports event and teams. The dynamic part 604, including players' names and events, is extracted over the length of the game and also stored in the SKDB 602.

The dynamic component includes parsing over each ADT unit. Each ADT is parsed into the following four items: Game-Time-Stamp 606; Player/Team-ID 608; Event-ID 610; and Score-value 612. That will be followed by an extraction performed on the PKW over a window of a fixed length, to extract the true sports event type and the associated player. Parsed ADTs within a time window ADTw are processed to extract player keywords and associated event keywords. For soccer or football an example window of 2 minutes may be used, since typically each soccer or football event has a longer duration than 1 minute.

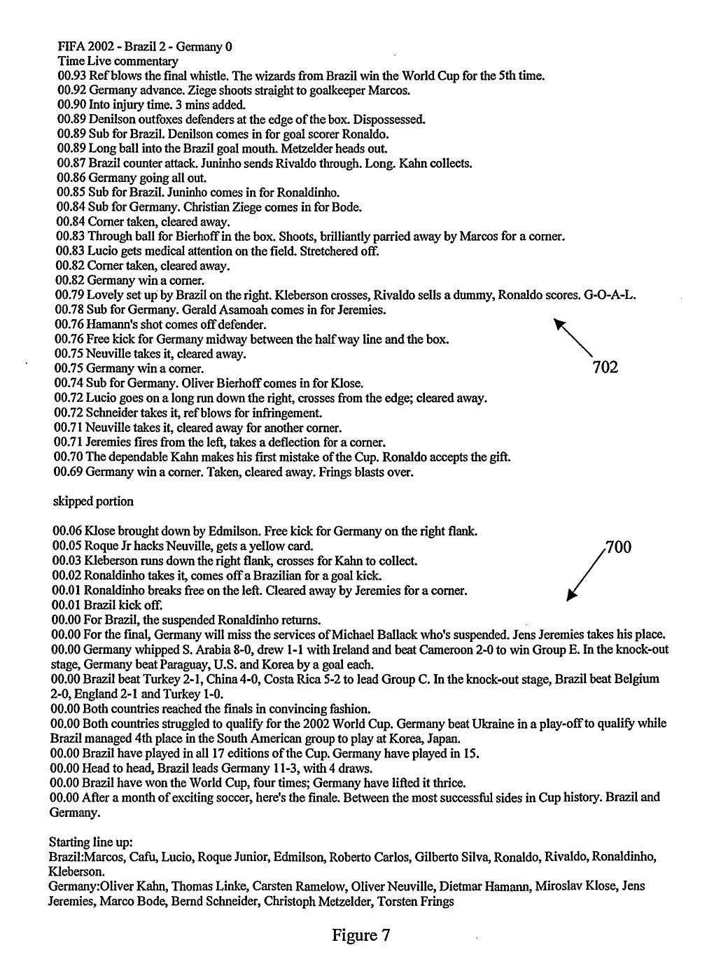

As shown in FIG. 7 the static part 700 of the play keyword eg: the name of the game, venue, teams, players from each team, and referees, etc, may be extracted at the beginning of the commentary. The dynamic component 702 of the play keyword may be extracted over the duration of the game.

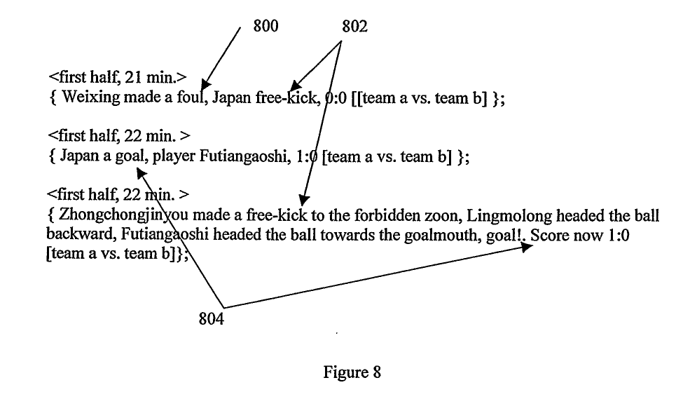

In sporting footage events may be inter-dependent instead of being considered as isolated events. As seen in FIG. 8 an event foul 800 may cause an event of free-kick 802, which in turn may result in a goal 804. Knowledge of such inter-relations may assist in segmenting events with accurate temporal boundaries for video summary or query. This process is called context sports event parsing.

### Video Analysis

Depending on the level of event granularity or temporal resolution required the VKW may be used to further refine the indexed location and the indexed boundaries in the footage used to represent the event. For example the event may be detected using just the PKW, resulting in an event window of about 1 minute. If the event is first identified using the PKW, the VKW may be used to refine the event window to a much shorter period. For example using the VKW, the event may be refined to the replay (already chosen by the human production director) of the event within the footage.

The VKW may also be used in synchronising the event boundaries within video stream and the STB stream.

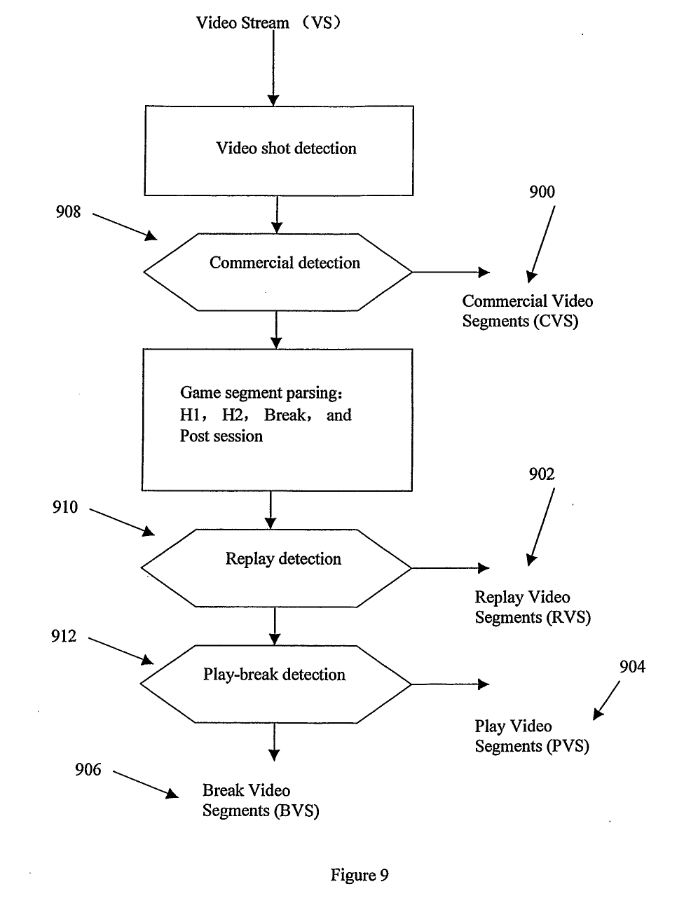

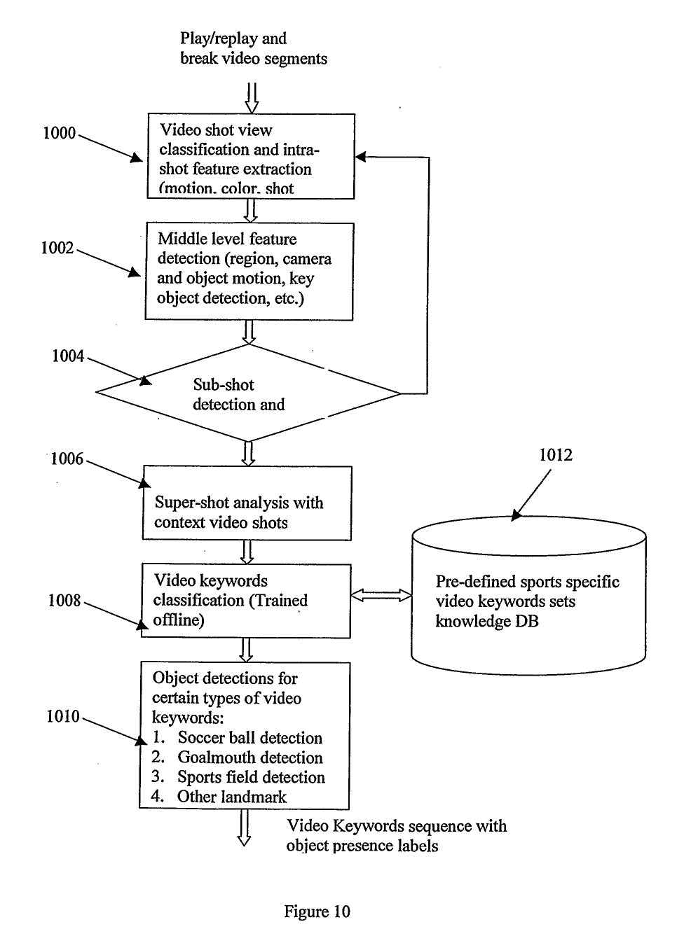

Video analysis (412 in FIG. 4) may involve video shot parsing as shown in FIG. 9 and/or VKW extraction and object detection as shown in FIG. 10. The video shot parsing and/or VKW extraction and object detection may be used to refine the indexing of the events in the footage.

Video shot parsing involves parsing the footage into types of video segments (VS). FIG. 9 shows extraction into commercial segments 900, replay segments 902; play video segments (PVS) 904 and break video segments (BVS) 906. The commercial segments 900 are detected using a commercial detection algorithm 908. The replay segments 902 are detected using a replay detection algorithm 910. The PVS 904 and BVS 906 are detected using a play-break detection algorithm. It is not necessary for all algorithms to be used. For example if only replays are required to be extracted, then only the replay algorithm is required. However the system may be employed more generally to extract any type of video segments from the footage.

An example of a commercial detection algorithm is disclosed in U.S. Pat. No. 6,100,941. TV commercials are detected based on whether a black frame has occurred. Other parameters are used to refine the process including the average cut frame distance, cut rate, changes in the average cut frame distance, the absence of a logo, a commercial signature detection, brand name detection, a series of black frames preceding a high cut rate, similar frames located within a specified period of time before a frame being analyzed and character detection.

An example of a replay detection algorithm is disclosed in a paper by L.Y. Duan, M. Xu, Q. Tian, CS Xu, entitled “Mean shift based video segment representation and applications to replay detection”, published in ICIP2004, Singapore. Replay segments are detected from sports video, based on mean-shift based video segmentation where both spatial and temporal features are clustered to characterize video segments. For example colours and motions may be utilized for clustering. Subsequently parameters of these clusters can be used to detect replays robustly because of special characteristics of the replay logos.

An example of a play-break detection algorithm is disclosed in a paper by L. Xie, S.-F. Chang, A. Divakaran and H. Sun, entitled “Structure Analysis of Soccer or football Video with Hidden Markov Models”, published in Proc. International Conference on Acoustic, Speech and Signal Processing, (ICASSP-2002), Orlando, Fla., USA, May 13-17, 2002. A HMM based method may be used to detect Play Video Segments (PVS) 904 and Break Video Segments (BVS) 906. Dominant colour ratio and motion intensity are used in a HMM models to model two states. Each state of the game has a stochastic structure that is modelled with a set of hidden Markov models. Finally, standard dynamic programming techniques are used to obtain the maximum likelihood segmentation of the game into the two states.

As shown in FIG. 10 after TV commercial segments have been removed, sports video segments, including play/break/replay segments will be processed to extract VKWs, the structure of which depend on the type of sports game. The rules for the VKW extraction for different sports types are stored in the knowledge database 1012.

There are at least three types of video keywords. A first type has a length of one video shot. A second type is a sub-video shot which is less than one video shot. Finally a third type is a super-video shot that covers more than one video shot.

An examples of a sub-video shot would be where one video shot can be rather long, including several rounds of camera panning which covers both defence and offence for a team, in for example basketball or football. In these situations it's better to segment these long video shots into sub-shots so that each sub-shot describes either a defence or an offence.

Similarly, a super-video shot relates to where more than one video shot can better describe a given sports event. For instance in tennis video, each serve starts with a medium view of the player who is preparing for a serve. The medium view is then followed by a court view. Therefore the medium view can be combined with the following court view to one semantic unit: a single video keyword to represent the whole event of ball serving.

The process of determining VKW types is now described. In step 1000 intra video shot features (colour, motion, shot length, etc.) are analyzed. In step 1002 middle level feature detections are performed to detect sports field region, camera and object motions. In step 1004 a determination is made as to whether sub-shot based video keywords should be considered. Sub-shot video keywords can be identified and refined through step 1000, step 1002 and step 1004. Similarly super-shot video keywords are identified in step 1006 so that one semantic unit can be formed to include several video shots.

In step 1008 a video keyword classifier parses the input video shot/sub-shot/super-shot into a set of predefined VKWs. Many supervised classifiers can be used, such as neural networks (NN), supporting vector machine (SVM).

In step 1010, various types of object detection can be used to further annotate these video keywords, including soccer ball or football, goalmouth, and other important land marks. This allows higher precision in synchronising events between the streams.

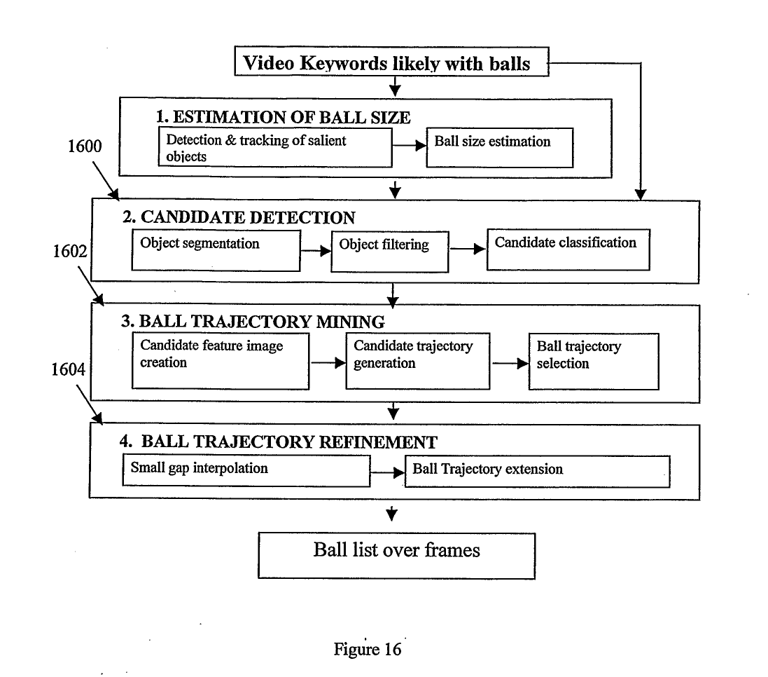

An example of object detection is ball detection. As shown in FIG. 16, in typical footage the soccer ball or football may be highly distorted due to many reasons, including high speed moving of the balls, and cameras' view changes, and occlusions of players, etc. Two methods may be used in combination to detect the ball trajectory to avoid distortion problems. Firstly ball candidates are detected 1600 by eliminating non-ball shape objects. Secondly the ball trajectory is estimated 1602 in the temporal domain. In this was any gaps or video shots missing the ball, (which may be caused by occlusion or ball being too small), can be compensate for.

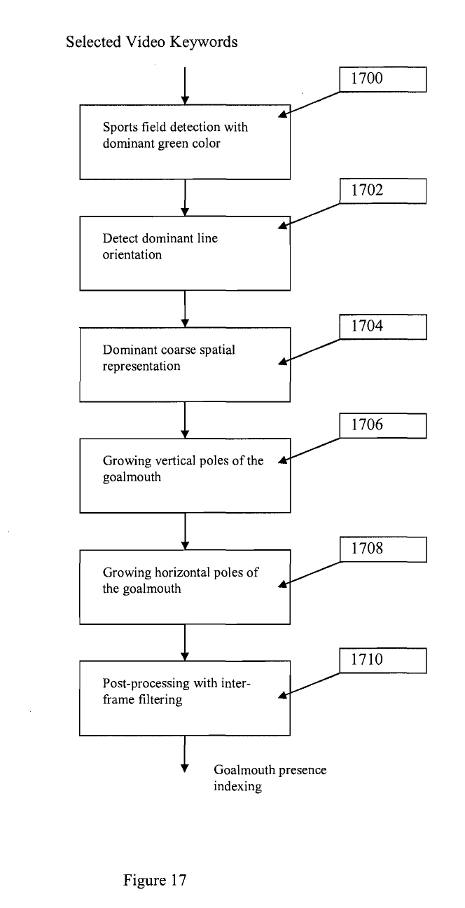

A further example of object detection is goalmouth location. The process is shown in FIG. 17 in which step 1700 encompasses the sports field being detected by isolating the dominant green regions. In step 1702 a Hough Transform-based line detection is performed on the sports field area. In step 1704 coarse level play field orientation detection is performed. In step 1706 vertical goalposts are isolated and in step 1708 horizontal goal-bar are isolated, by colour-based region (pole)-growing. In step 1710 post-processing is used to detect the localized goalmouth from the input video.

### Audio Analysis

Similarly to VKW, the AKW may be used to further refine the indexed location and the indexed boundaries in the footage used to represent the event. The AKW may also be used in synchronising the event boundaries within audio stream and the STB stream.

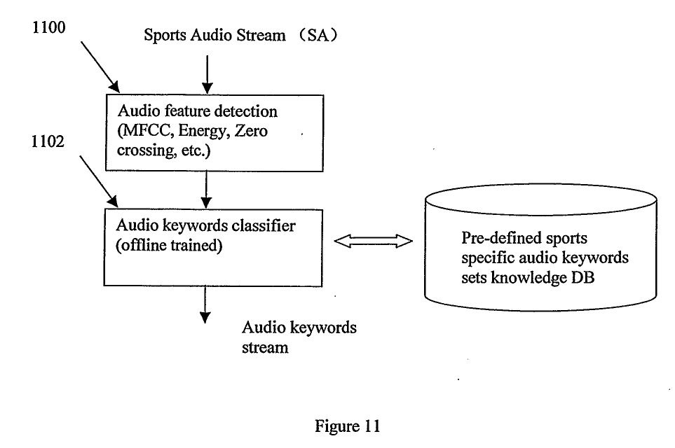

FIG. 11 shows the process of AKW extraction (414 in FIG. 4) from the audio stream. The AKW is defined as a segment of audio where we can observe the presence of several classes of sounds with special meaning to semantic analysis of sports events. For instance, the excited or plain voice pitches of the commentator's speech or the sounds of the audience, etc may be indicative of an event. It is very useful to detect these special sounds robustly to associate with varying sports events.

Some example AKWs are listed below. AKWs may either be generic or sports specific.

### Generic Audio Keywords

Plain Commentator Speech
Excited Commentator Speech
Plain Audience Sounds
Excited Audience Sounds

### Domain-Specific Audio Keywords

Whistling in Basketball and Soccer or Football
Hitting Ball in Tennis

Low level features 1100 that may be used for AKW extraction include Mel frequency Cepstral Coefficients (MFCC), Zero Crossing Rate (ZCR), linear prediction coefficient (LPC), short time energy (ST), spectral power (SP), and Cepstral coefficients (CC), etc. The audio data is sampled from the audio stream at a 44.1 KHz sample rate, stereo channels and 16 bits per sample.

The MFCC features may be computed from the FFT power coefficients of the audio data. A triangular band pass filter bank filters the power coefficients. The filter bank consists of K=19 triangular filters. They have a constant mel-frequency interval, and cover the frequency range of 0 Hz-20050 Hz. The Zero crossing rate may be used for analysis of narrowband signals, although most audio signals may include both narrowband and broadband components. Zero crossings may also be used to distinguish between applause and commentating.

Supervised classifiers 1102 can be used for AKW extraction such as multi-class support vector machine (SVM), decision tree and hidden Markov model (HMM). Samples of the pre-determined AKW samples are prepared first, classifiers can be trained over the training samples, and then they can be tested over testing data for performance evaluation.

### Time Alignment

Cross-media alignment (418 in FIG. 4) using time-stamps embedded in the sports video/audio and STB streams may be required, as the timing of each stream may not be synchronised. Alternatively a machine learning method such as HMM may be used to make such corrections, which is useful to correct any delays the STB texts.

### Player, Team and Event Detection

It may be useful, depending on the application, to detect events within the footage, and annotate the footage with this additional information.

In a first example events are detected (step 104 in FIGS. 1 and 419 in FIG. 4) by analyzing the STB stream. The PKW extracted from the STB stream is used to detect events. The association between the PKW and an event is based on knowledge based rules. In FIG. 4 rules are stored in the knowledge database 424. For example PKW such as goal or foul in the SWT provides a time stamp for an event. Then the boundaries of the event are detected using the VKW and AKW and the streams synchronised.

The player and team involved in each event are determined based on an analysis of the surrounding PKW.

In the second example events are identified based on the video stream. As one possible case, in the first example, the visual analysis previously described is used to detect each of the replays inserted by the human production director. Each of the replays is then annotated, and stored in a database. Various methods may be used to analyse the video stream and associate with events. For example with machine learning methods such as neural networks, supporting vector machines, and hidden markov models, may be used to detect events in this configuration.

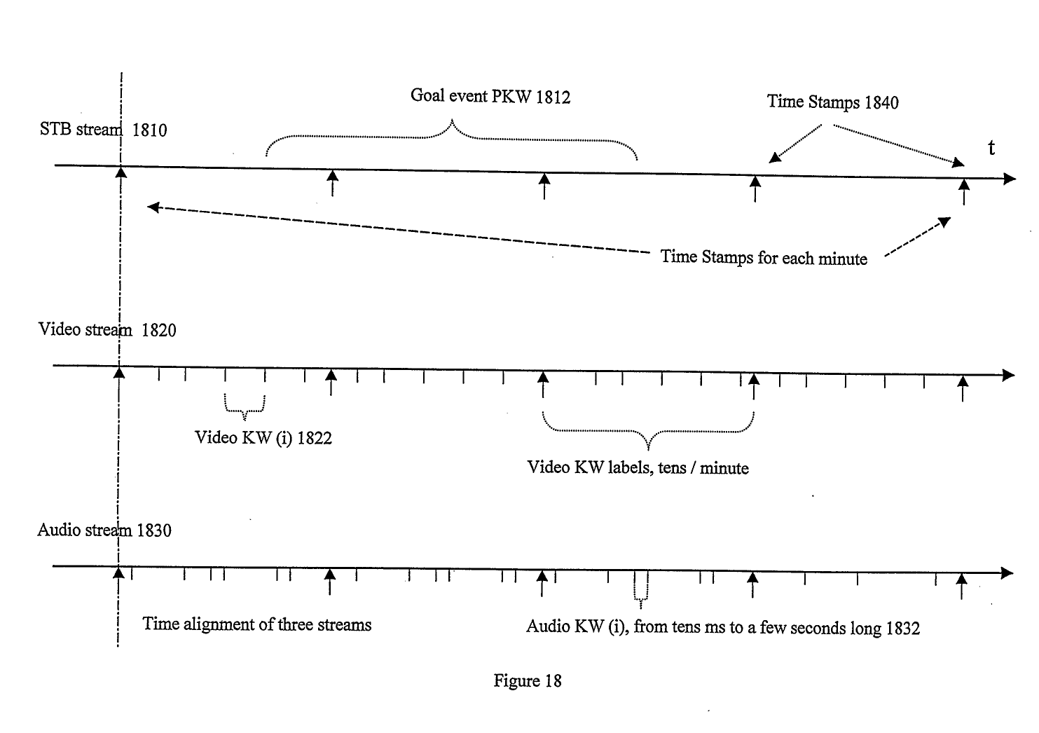

As seen in FIG. 18 the footage is stored in the database once fully annotated. Three parsed streams are stored including STB stream 1810, video stream 1820 and audio stream 1830. As we can see that PKW 1812 from the STB are time stamped at each minute 1840 while VKW 1822 and AKW 1832 are indexed at seconds and milliseconds intervals. Three streams can be fused together for various applications such as event detection, classification, and personalized summary. Based on the required granularity of particular applications, one, two or three streams can be used for generation of summary video. They can be used either in sequence or in parallel.

### Replay Classification

It may also be useful, depending on the application, to detect and classify replays (420 in FIG. 4) within the footage, and annotate the footage with this additional information.

Replay detection and classification is described in detail in other sections. Thus the indexing and classification of replays simply forms another level of semantic annotation of the footage once stored in the database.

### Generation of Personalised Video Summary

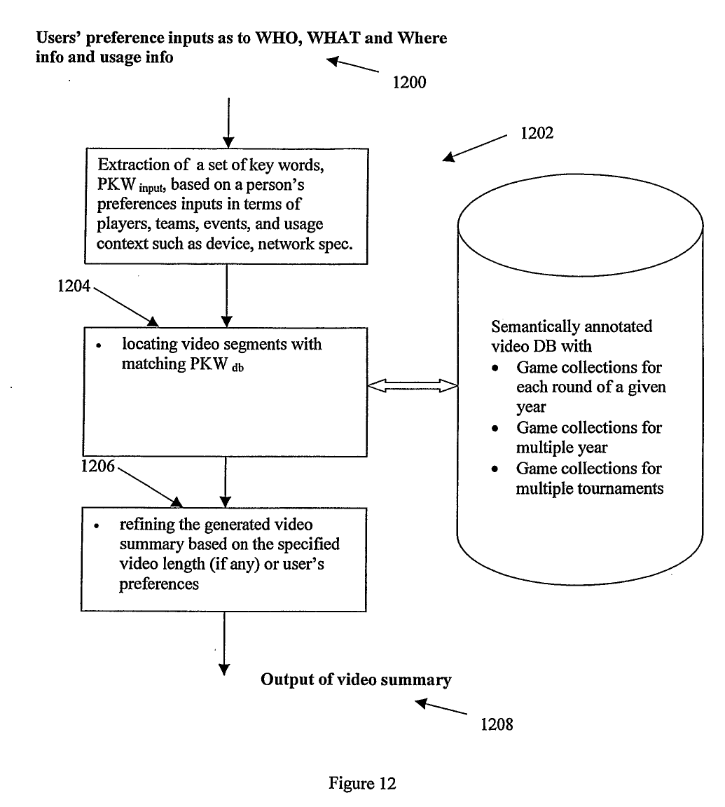

According to a first embodiment FIG. 12 shows procedures of personalized video summary based on large content collections with multiple games of many tournaments. In step 1200, users give their preferences on their desired video summary, possibly including players, teams or specific sports events, and possible other usage constrains like the total length of the output video, etc. In step 1202, a set of PKW input can be identified based on users' input. In step 1204 the annotated sports video content database is searched using the set of PKW input to locate corresponding game video segments. In step 1206 the selected segments are refined 1208 based on a preferred length or other preferences. In step 1208 the video summary is generated.

For instance, a video summary of all the goals by the football star David Beckham's can be created by identifying all games for this year, and then identifying all replays associated with David Beckham and selecting those replays that involve a goal.

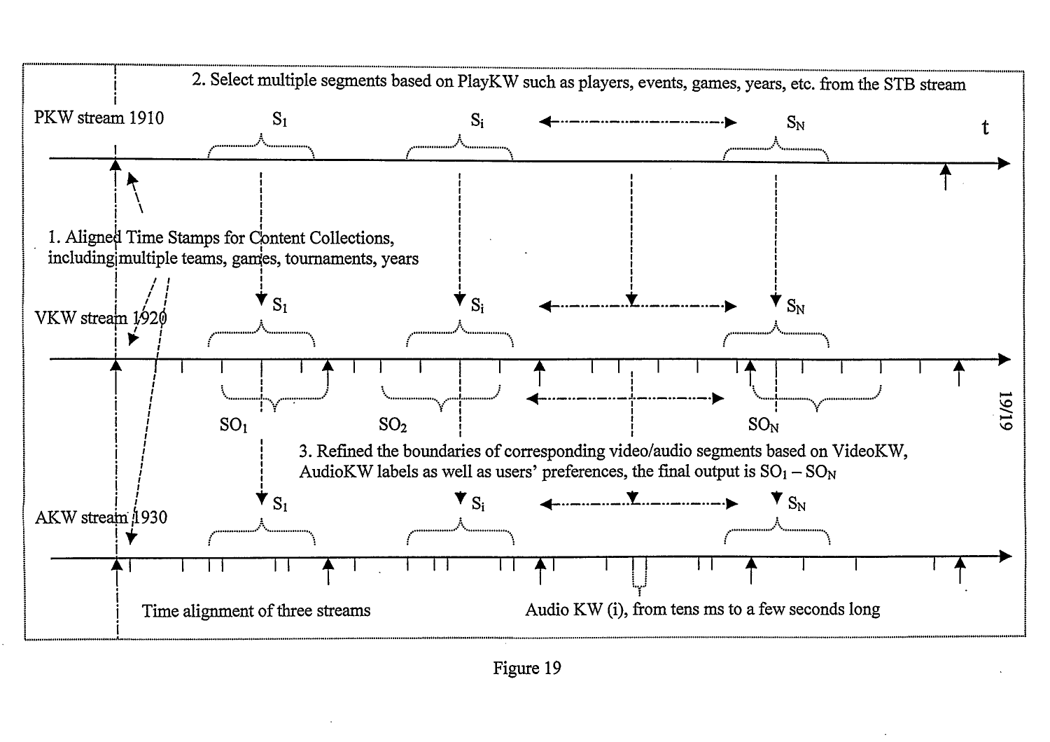

FIG. 19 shows the above created summary can be refined by using VKW 1920 and AKW 1930 where boundaries of video/audio segments can be adjusted based on boundaries of VKW 1920 and AKW 1930 instead of relying on PKW 1910 only which has a granularity of one minute. Machine learning algorithms such as HMM models, neural networks or supporting vector machines, can perform the boundary adjustment.

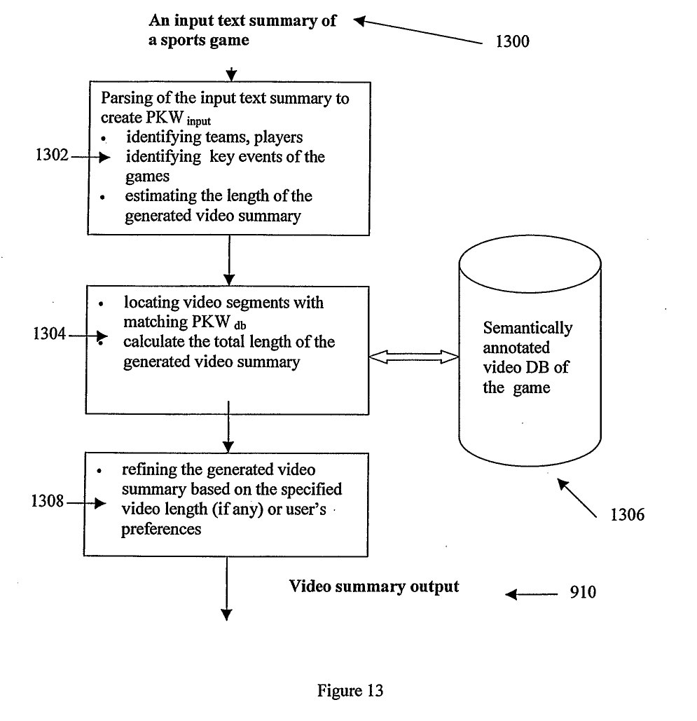

According to a second embodiment FIG. 13 shows how a video summary might be generated from an annotated sports video using a text summary of the game. A typical text summary of a sports game consists of around 100 words, including names of teams, outcome of the game, and highlights of the game.

Firstly the text summary 1300 is parsed to produces a sequence of important action items 1302 identified with key players, actions and teams, and other possible additional information such as time of the actions, name and location of the sports games. This generates the preferences (200 in FIG. 2) for the event selection.

SWT parsing produces sequences of time-stamped PKWs that describe actions taking place in the sports game. The event boundaries are refined and aligned with the video stream and audio stream, and the annotated video is stored in a database 1306.

The preferences from the text summary are then used to select 1304 which events to include (step 202 in FIG. 2) by searching the database 1306. Sports highlightlevents candidates are organized based on a set of pre-defined keywords for given sports; for example, sports highlights for soccer or football include goal, free kick, corner kick, etc. All these sports keywords are used in both text summary and text broadcasting script.

The selection of events may be further refined 1308, depending on preferred length of summary or other preferences.

Finally, the video summary 1310 is generated (204 in FIG. 2) based on the video shots and audio corresponding to the time-stamped action items selected above.

According to a third embodiment, a learning process may be used for detecting and classification of replays, and summary generation. Video replays are widely used in sports game broadcasting to show highlights occurred in various sessions of the broadcasting. For typical soccer or football games there are 40-60 replays generated by human production directors for each game.

There are three types of replays generated at three different stages of broadcasting. Instant replay video segments RVSᵢₙₛₜₐₙₜ appear during regular sessions such as first half and second half of games. Break replay video segments RVS_{break} and post-game replay video segments RVSₚₒₛₜ appear during the break sessions between two half play sessions, and the post-game sessions. On average, there are 30-60 RVSᵢₙₛₜₐₙₜ for each soccer or football game while numbers of RVS_{break}, RVSₚₒₛₜ are much smaller because only the most interesting actions or highlights can be selected for showing during the break and post-game sessions.

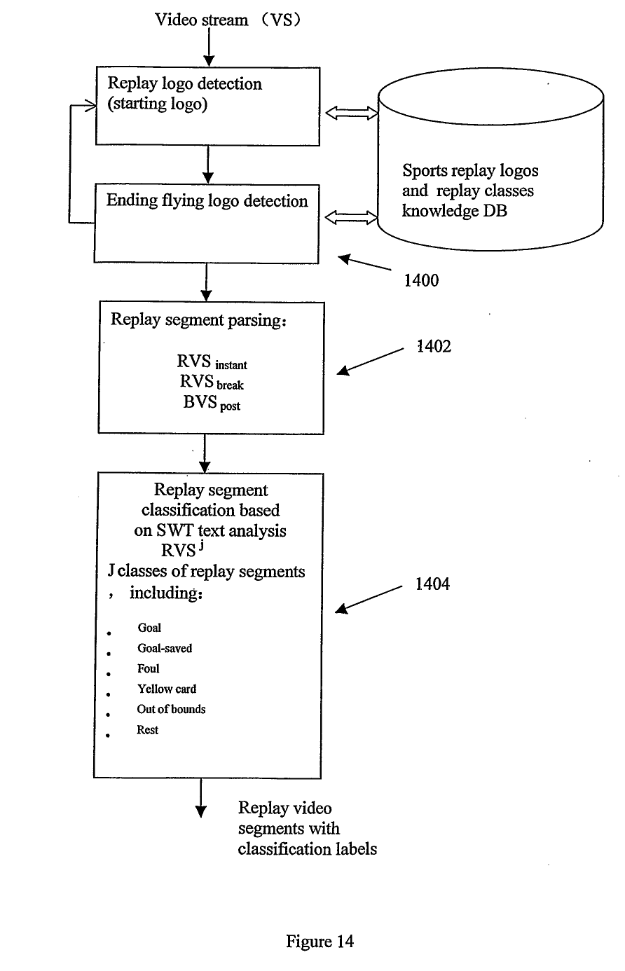

FIG. 14 shows a method of detecting and classifying replays. In step 1400 video analysis is used to detect a replay logo within the footage, to detect each event. In step 1402 the type of replay identified such as RVSᵢₙₛₜₐₙₜ, RVS_{break} and RVSₚₒₛₜ. In step 1404 each replay is then classified into a pre-defined set of event categories 1404 such as such as goal, goal-saved, goal-missed, foul etc using analysis of the STB stream. Once an RVSᵢₙₛₜₐₙₜ is detected the PKW is analysed in the preceding time period (0.5˜1.0 minutes) to identify the category.

For a soccer or football game, where the total number of replays are denoted N-RVSᵢₙₛₜₐₙₜ, N-RVS_{break}, N-RVSₚₒₛₜ, then N-RVS_{break}, and N-RVSₚₒₛₜ are much smaller than N-RVSᵢₙₛₜₐₙₜ. Since human production directors carefully select N-RVS_{break} and N-RVSₚₒₛₜ from N-RVSᵢₙₛₜₐₙₜ, the selection process done by human directors can be learned. The learning process may involve a machine learning methods such as neural networks, decision trees or supporting vector machines such so that different weightings or priorities can be given to different types of N-RVSᵢₙₛₜₐₙₜ, even together with consideration of users' preference to create more precise video replays for users.

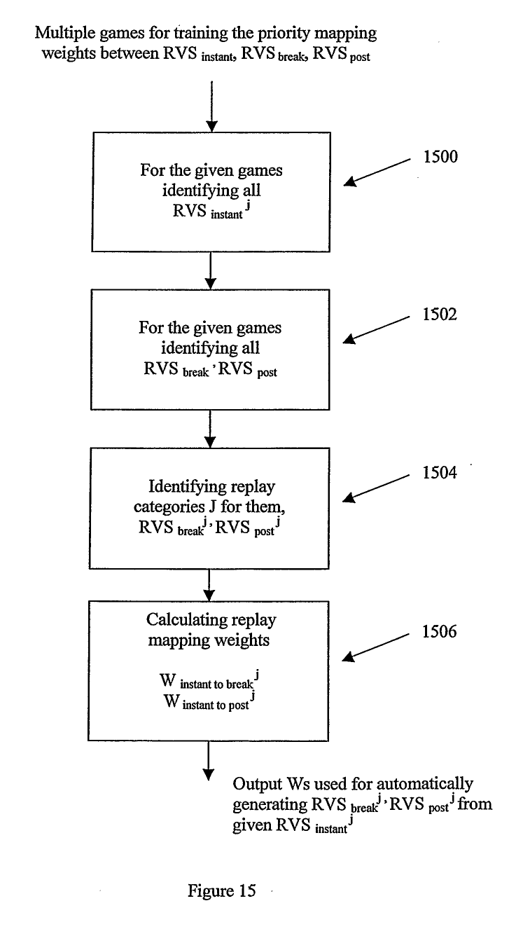

FIG. 15 shows an example learning process. The video and web-casting text data is collected for multiple games. For each game all RVSᵢₙₛₜₐₙₜ 1500 and RVS_{break} RVS post for 1502 are identified. Then each replay break is categorised 1504 by visual and audio analysis with manual corrections if needed. Then machine learning is used to calculate the weighting factors 1506 for different types of replay, j, from the two collections. These weighing factors then reflect how human production directors use replays when they create RVS_{break} and RVSₚₒₛₜ.

Based on the detected and classified RVS Instant as well as the learned weighting factors in terms of their importance, a selection can be made of the RVSᵢₙₛₜₐₙₜ to generate the personalised video summaries automatically.

It will be appreciated by a person skilled in the art that numerous variations and/or modifications may be made to the present invention as shown in the example embodiments without departing from the spirit or scope of the invention as broadly described. The example embodiments are, therefore, to be considered in all respects to be illustrative and not restrictive.

1. A method of annotating footage that includes a structured text broadcast stream, a video stream and an audio stream, comprising the steps of:
extracting directly or indirectly one or more keywords and/or features from at least said structured text broadcast streams,
temporally annotating said footage with said keywords and/or features
analysing temporally adjacent annotated keywords and/or features to determine information about one or more events within said footage.

2. The method claimed in claim 1 wherein said step of analysing temporally adjacent annotated features and/or temporal information comprises:
detecting one or more events in said video footage according to where at least one of said keywords and/or features meets one or more predetermined criterion, and
determining information about each detected event from annotated keywords and/or features temporally adjacent to each detected event.

3. The method claimed in claim 2 wherein said step of detecting one or more events comprises the step of comparing at least one keyword and/or feature extracted from the structured text broadcast stream to one or more predetermined criterion.

4. The method claimed in claim 2 wherein said step of determining information comprises the step of indexing each of said events using a play keyword extracted from said structured text broadcast stream.

5. The method claimed in claim 4 wherein said step of indexing further comprises the step of indexing each of said events using a time stamp extracted from said structured text broadcast stream.

6. The method claimed in claim 5 wherein said step of indexing further comprises the step of refining the indexing of each of said events using a video keyword extracted from said video stream.

7. The method claimed in claim 5 wherein said step of indexing further comprises the step of refining the indexing of each of said events using an audio keyword extracted from said audio stream.

8. The method claimed in claim 2 wherein said video footage relates to at least one sportsperson playing a sport, and said step of extracting further comprising the step of extracting which sportsperson features in each event from the structured text broadcast stream, and said step of annotating comprises annotating said footage with said sportsperson.

9. The method claimed in claim 8 wherein said step of extracting further comprising the step of extracting when each event occurred, what happened in each event and where each event happened from at least one of said streams, and wherein said step of annotating further comprises annotating said footage according to when each event occurred, what happened in each event and where each event happened.

10. The method claimed in claim 2 wherein said structured text broadcast is sports webcasting text (SWT).

11. The method claimed in claim 2 wherein said keywords and/or features comprises one or more keyword(s), and wherein each keyword is determined from one or more low level features, and wherein each low level feature is extracted from said footage.

12. The method claimed in claim 11 wherein said one or more keyword(s) comprises a play keyword extracted from said structured text broadcast stream, a video keyword extracted from said video stream and an audio keyword extracted from said audio stream.

13. The method claimed in claim 12 wherein said event comprises a state of increased action within the footage chosen from one or more of the following list: goal, free-kick, corner kick, red-card, yellow-card, where the action is soccer footage.

14. The method claimed in claim 13 wherein said one or more predetermined criterion comprises said play keyword matching one of said states of increased action.

15. A data store for storing video footage, configured to store the annotated footage of claim 1.

16. A method of generation of a personalised video summary comprising the steps of:
storing video footage including one or more events, wherein each of said events is classified according to the method claimed in claim 2;
receiving preferences for said personalised video summary;
selecting events to include from said stored video footage where the classification of a given event satisfies said preferences; and
generating said personalised video summary from said selected events.

17. A system for annotating footage comprising
a data store configured to store said footage and a computer program;
a processor configured to execute said computer program to carry out the steps of the method according to claim 1.

18. A system for generation of a personalised video summary comprising
a data store configured to store said footage and a computer program;
a processor configured to execute said computer program to carry out the steps of the method according to claim 16.
